(19) United States
(12) Patent Application Publication
(10) Pub. No.: US 2009/0015872 A1
(43) Pub. Date: Jan. 15, 2009

(54) Line Printer and Half Toning Processing Method

(75) Inventor: Toshiaki KAKUTANI, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/170,336

(22) Filed: Jul. 9, 2008

(30) Foreign Application Priority Data
Jul. 11, 2007 (JP) 2007-182316

(51) Int. Cl. G06K 15/00

(52) U.S. Cl. 358/3.13; 358/3.06

(57) ABSTRACT

A printer uses a dithering mask having a width that is 1/N (where N is a nonzero positive integer) times a number of pixels corresponding to the layout pitch of print head tips, so as to always have an identical positional relationship between the dithering mask and the connecting portions of the print head tips, so as to perform a half toning process and print image data. The dithering mask DM is a dithering mask that is optimized so as to be able to obtain dot dispersion characteristics that are somewhat good regardless of the positional shift patterns between the print head tips. Doing so enables the suppression of degradation of printed image quality that stems from differences in characteristics of the plurality of print heads in a line printer that performs printing using a plurality of print heads that are arrayed across a printing range. This also enables efficient half toning processing to be performed by reducing extremely the overhead in producing dithering masks that take into consideration the positional shifts between the plurality of print heads.

### CLAIM OF PRIORITY

The present application claims priority from Japanese application P2007-182316A filed on Jul. 11, 2007, the content of which is hereby incorporated by reference into this application.

### BACKGROUND

1. Field of the Invention

The present invention relates to a line printer that for printing specific image data by forming dots on a single raster through a plurality of print heads that are disposed across a printing range.

2. Description of the Related Art

In inkjet-type line printers, ink droplets are sprayed from nozzles of print heads that are disposed in essentially a single line in a direction that is perpendicular to the direction of feeding of printer paper as the printer paper is being fed, to adhere to the printer to print text and graphics.

In line printers, in a thermal printer, for example, typically a printer head is formed with a plurality of print heads disposed in a line. The use of a plurality of print heads in this way is to improve the yields of the printer heads that are manufactured by being cut out of disk-shaped silicon substrates. A line printer that is structured in this way is a known technology described in, for example, Japanese Unexamined Patent Application Publication 2001-71495.

In a line printer that is structured with a plurality of print heads in a line, as described above, problems in manufacturing tolerances give rise to differences in characteristics, if even a minute, between print heads. When lined up in this way and printing using a half toning process that applies a specific dithering mask to a pixel region along two printing heads it is not possible to obtain a specific dot dispersion characteristic due to the differences in characteristics between two print heads, which causes degradation in the printed image quality.

Additionally, in a line printer that is structured by disposing a plurality of print heads in a line, as described above, the diameter of a single dot is extremely small when printing with high image quality. For example, when printing at 600 dpi, the diameter of a single dot is about 40 μm. Given this, a shift of the placement position of the print head from the proper position, even if minute, will cause a degradation in the printing quality. Securing this type of extremely high precision positioning, is extremely difficult in practice, and thus a degradation of printing quality due to positional shift of the print head is a problem inherent to this type of line printer.

### SUMMARY

The problem described above to be solved by the present invention is that of suppressing degradation caused by discrepancies in the characteristics of a plurality of print heads in a printer that is provided with a plurality of print heads disposed in a line across the range of printing. An additional object of the present invention is to perform an efficient half toning process by greatly reducing the overhead in generating a dithering mask that takes into account positional shift between the plurality of printing heads.

The present invention was created in order to solve, at least in part, the problem described above, and can be embodied in the forms or preferred embodiments described below.

A first line printer comprises:

a plurality of print heads arrayed with an identical pitch in a line across a printing range;

half toning unit that performs a half toning process, on image data, using a dithering mask that has a size that is a multiple of 1/N (where N is a nonzero positive integer) times a number of pixels corresponding to the print head pitch; and

printing unit that drives said print heads according to the results of the half toning process to form an image through forming dots on a single raster.

In a line printer of this structure, the size of the dithering mask in the direction of layout is a multiple of 1/N (where N is a nonzero positive integer) times the number of pixels corresponding to the print head pitch, so the print head and the dithering mask have a positional relationship wherein the connecting portion of the print head matches the interface between dithering masks. Consequently, because there is no application of a single dithering mask spanning printing regions corresponding to the plurality of print heads it is possible to suppress the degradation in printed image quality due to differences in characteristics between print heads.

A second line printer comprises:

a plurality of print heads arrayed with at least two different layout pitches in a line across a printing range;

half toning unit that performs a half toning process, on image data, using a dithering mask that has a size that is a multiple of 1/N (where N is a nonzero positive integer) of a greatest common factor of the number of pixels corresponding to the plurality of print head pitches in a direction in which the print heads are arrayed; and

printing unit that drives said print heads according to the results of the half toning process to form an image through forming dots on a single raster.

In a line printer of this structure, the size of the dithering mask in the direction of layout is a multiple of 1IN (where N is a nonzero positive integer) times the greatest common factor of the number of pixels corresponding to the print head pitch, so the print head and the dithering mask have a positional relationship wherein the connecting portions of the print heads match the junctions between dithering masks. Consequently, because there is no application of a single dithering mask spanning printing regions corresponding to the plurality of print heads, it is possible to suppress the degradation in printed image quality due to differences in characteristics between print heads.

In this type of line printer;

said plurality of print heads comprise at least three print heads; and

the dithering mask is generated taking into account dot distribution characteristics when adjacent print heads are located at a position shifted in a specific direction and in a specific distance from a target position.

In a line printer structured in this way, a half toning process can be performed wherein a dithering mask can be applied so that there will always be the same positional relationship between the connecting portion with the print head and the dithering mask that is produced taking into consideration the dot dispersion characteristics when there is a positional shift. Consequently, it is possible to repetitively apply the same dithering mask that is generated taking the dot dispersion characteristics into account when there is a positional shift, meaning that it is not necessary to provide different dithering masks for each print head connecting portion, reducing the overhead in the dithering mask generation. This also enables efficient half toning processing.

Note that in addition to the line printer described above, the present invention can be structured also as a method by which a computer performs a half toning process, or as a dithering mask.

### BRIEF DESCRIPTION OF THE DRAWINGS

FIG. 1 is an explanatory diagram illustrating the schematic structure of a printer 8 as an embodiment according to the present application;

FIG. 2 is an explanatory diagram illustrating the detailed structure of a printer head 70;

FIG. 3 is a flow chart illustrating the flow of the image printing process of the printer 8;

FIG. 4 is an explanatory diagram illustrating conceptually the state wherein a dithering mask is referenced to determine whether or not a dot is to be formed for each pixel;

FIG. 5 is an explanatory diagram illustrating an postulated print head tip positional shift pattern;

FIG. 6 is a flow chart illustrating the flow in the method for generating an dithering mask for use in a half toning process;

FIG. 7 is an explanatory diagram for a dithering mask unit in the optimization of the dithering mask; and

FIG. 8A through FIG. 8D are explanatory diagrams illustrating an application of a dithering mask.

### DESCRIPTION OF THE PREFERRED EMBODIMENTS

### A. Embodiments

### A-1. Schematic Structure of the Printer 8

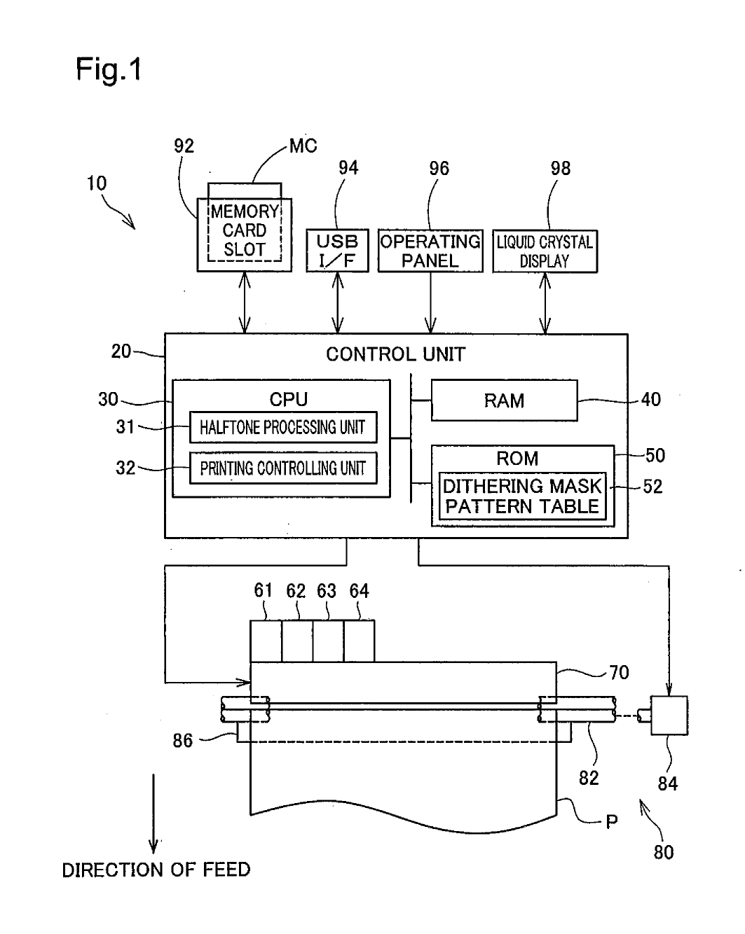

FIG. 1 is an explanatory diagram illustrating a schematic structure of a printer 8 as an embodiment as set forth in the present application. The printer 8 is an inkjet-type line printer, and, as shown in the figure, comprises a control unit 20, ink cartridges 61 through 64, a printer head 70, a paper feeding mechanism 80, and the like. The ink cartridges 61 through 64 correspond to the respective inks that produce the colors of cyan (C), magenta (M), yellow (Y), and black (K). Of course, the types and numbers of inks are not limited thereto.

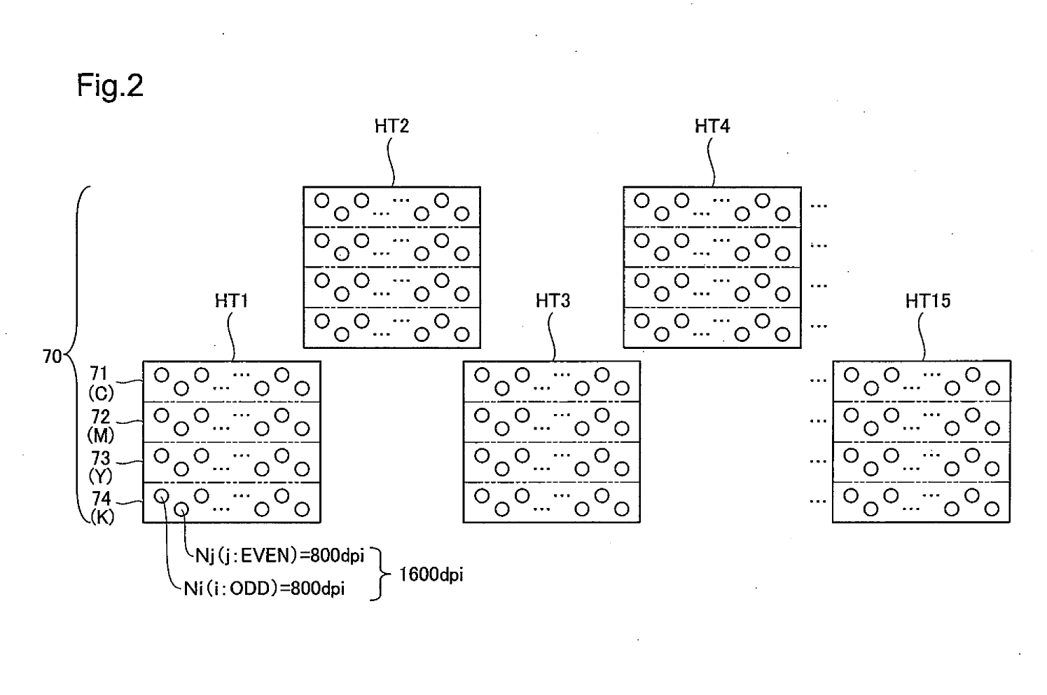

The printer head 70 is a line head-type printer head, and is provided with a plurality of thermal-type nozzles disposed in essentially a line on the bottom surface thereof. Each of the inks in the ink cartridges 61 through 64 is provided to a nozzle that is positioned on the bottom surface of the printer head 70 through an introduction tube, not shown, and ink is sprayed from these nozzles to perform the printing on printer paper P. the details of the printer head 70 will be explained below using FIG. 2.

The paper feeding mechanism 80 is provided with a paper feeding roller 82, a paper feeding motor 84, and a platen 86. The paper feeding motor 84 rotates the paper feeding roller 82 to convey the printer paper P, which is disposed between the printer head 70 and the plate-shaped platen 86, in a direction that is perpendicular to the axial direction of the paper feeding roller 82.

The control unit 20 is structured from a CPU 30, a RAM 40, and a ROM 50, and controls the operation of the aforementioned printer head 70, the paper feeding motor 84, and the like. The CPU 30 deploys to the RAM 40 a control program that is stored in the ROM 50, and executes said control program to operate as a half toning processing unit 31 and a printing controlling unit 32. The functions of these functioning units will be described in detail below. A control program for controlling the operation of the printer 8 is stored in the ROM 50, and a dithering mask pattern table 52, which is used in the half toning process described below, is also stored in the ROM 50.

Additionally, a memory card slot 92 into which a memory card MC on which is recorded image data D is inserted, a USB interface 94 for connecting devices such as a digital camera, an operating panel 96 for performing a variety of operations relating to printing, and the liquid crystal display 98 for displaying a user interface (UI) are connected to the control unit 20.

A-2. Detailed Structure of the Printer Head 70:

FIG. 2 is an explanatory diagram illustrating the detailed structure of the printer head 70. As is shown in the figure, the printer head 70 in the present embodiment is structured with 15 sets of print head tips HT 1 through HT 15, lined up in a zigzag pattern, in which are formed nozzle arrays 71 through 74 that each spray inks of respective colors C, M, Y, and K. The length of a single print head tip is approximately 20 mm. A single ink that is sprayed from these head tips forms dots in a single raster through coordinating the timing of the paper feed and spraying of the ink. Note that the print head tips HT 1 through HT 15 in the present embodiment are formed in a zigzag pattern in consideration of issues of space for the placement of ancillary devices and issues of strength of the end of the print head tip, but may instead be formed in a straight line.

Additionally, in the nozzle arrays 71 through 74, the nozzles in each are formed arrayed in a zigzag pattern. The odd-numbered nozzles Ni (where i is odd) and the even-numbered nozzles Nj (where j is odd) are arrayed with a density of 800 dpi each. The inks that are sprayed from the odd-numbered nozzles Ni and the even-numbered nozzles Nj form dots on the same raster through coordinating the spraying with the paper feeding mechanism 80. Consequently, the nozzle arrays 71 to 74 each has a nozzle density totaling 1600 dpi. A single print head tip has 1280 nozzles, and if one pixel is expressed in terms of four dots in the vertical direction and four dots in the horizontal direction, then the length of a single print head tip corresponds to 320 printing pixels.

The pitch of the print head tips HT 1 through HT 15 (corresponding to 320 pixels) is N (where N is a nonzero positive integer) times the width of the dithering mask that is used in the half toning process, described below. The reasons for this will be described below.

Note that the printer 8 in the present embodiment uses a thermal-type inkjet-type printer, but is not limited thereto, and should be a line printer that performs printing of specific image data through forming dots on a single raster from a plurality of print heads. For example, the inkjet printer may be of a piezo type or some other ink spray method, or may be of a dot impact-type printer or a printer of another printing method.

Additionally, in the present embodiment the print head tips HT 1 through HT 15 are formed so that there are no locations of overlap, in the direction in which the print head tips are lined up, between the nozzles of the individual print heads; however, such an overlapping form is also acceptable.

A-3. Overview of the Image Printing Process

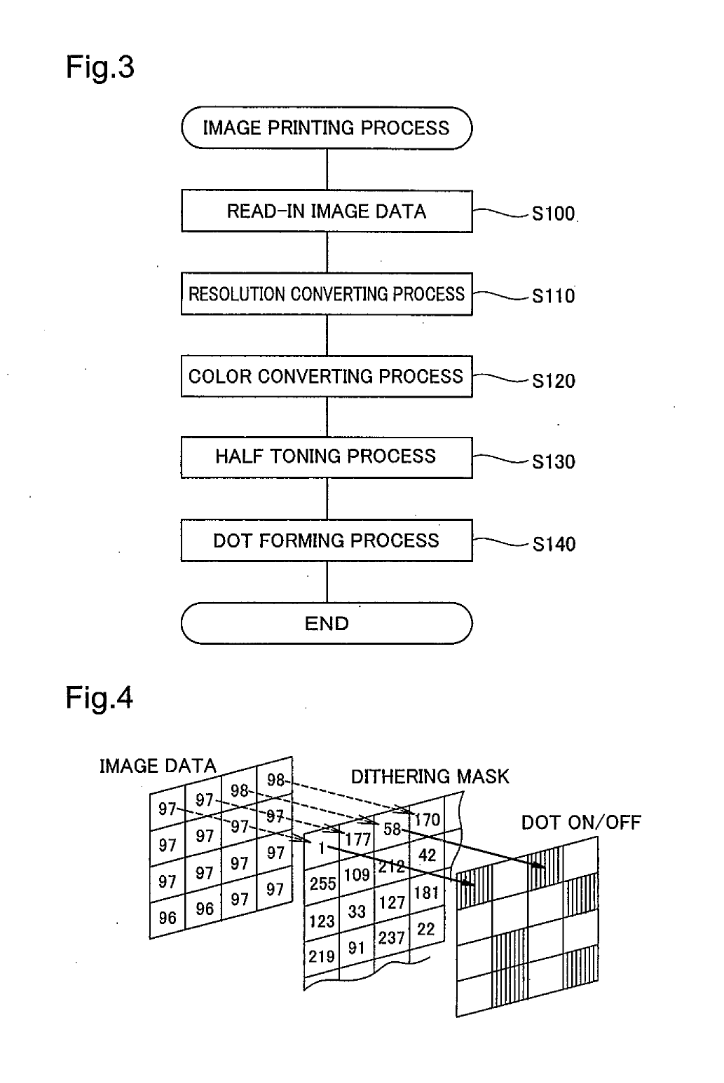

FIG. 3 is a flowchart illustrating the flow of processing for the printer 8 to print image data D by converting the image data read the into dot data that expresses whether or not a dot is to be formed, through applying specific image processing to the image data D that is stored in the memory card MC.

When the image printing process commences, the control unit 20 reads in the image data D to be printed from the memory card MC (Step S80). Here the image data will be explained as being RGB color image data, but the present invention is not limited to being colored image data, but instead can be applied similarly for monochrome image data as well.

When the image data D is read in, the control unit 20 performs a resolution converting process (Step S18). The resolution converting process is a process for converting the resolution of the image data that has been read in into the resolution (the printing resolution) at which the printer 8 will print the image. When the printing image resolution is higher than the resolution of the image data, then interpolation calculations are performed to increase the resolution through generating new image data between pixels. Conversely, if the image data resolution is higher than the printing resolution, then the resolution is degraded through thinning, with a specific ratio, the image data that has been read in. In the resolution converting process, the resolution of the image data D is converted to the printing resolution through performing this operation.

Once the resolution of the image data D is converted in this way to the printing resolution, then the control unit 20 performs a color converting process (Step S120). The color converting process converts RGB color image data, which is expressed through a combination of R, G, and B gradation values, into image data expressed by a combination of gradation values of the individual colors that are used for printing. As described above, the printer 8 uses four colors of ink, C, M, Y, and K, to print the images. Given this, in the color converting process in the present embodiment, a process is performed to convert the image data that is expressed by the RGB colors into data expressed by gradation values for each of the colors C, M, Y, and K.

When the gradation data for the individual C, M, Y, and K colors are obtained in this way, the control unit 20 performs a half toning process as the process of the half toning processing unit 31 (Step S130). This process generates dots at the appropriate density depending on the gradation value of the gradation data, and is a process to determine whether or not dots will be formed for each pixel, and a dithering method is used in the present embodiment. The dithering method is a method that determines whether or not dots will be formed for each individual pixel through comparing, for each individual pixel, a threshold value, established in a dithering mask, to the gradation value of the image data.

The aforementioned dithering method will be described in detail using FIG. 4. FIG. 4 is an explanatory diagram illustrating conceptually the state wherein the dithering mask is referenced to determine whether or not a dot is to be formed for each individual pixel. When making the determinations as to whether or not dots are to be formed, first a pixel for which the decision is to be made is selected, and the gradation value of the image data for it that pixel is compared to a threshold value that is stored in a corresponding location in the dithering mask. The arrows indicated by the fine dotted lines in FIG. 4 illustrate schematically the comparisons of the gradation values of the image data to the threshold values that are stored in the dithering mask, for each individual pixel. For example, for the pixel that is at the upper left corner of the image data, the gradation value of the image data is 97, and the threshold value in the dithering mask is 1, and so it is determined that a dot is to be formed in this pixel. The arrows indicated by the solid lines in FIG. 4 illustrate schematically the state wherein, for these pixels, the determination is that dots are to be formed, where the determination results are written to memory.

On the other hand, for the pixels at the right edge of these pixels, the gradation value for the image data is 97 and the threshold value in the dithering mask is 177, and thus it is the gradation value that is higher, so that the decision is to not form dots for these pixels. In the dithering method the dithering mask is referenced in this way to determine whether or not dots are to be formed for each individual pixel, to thereby convert the image data into data indicating whether or not to form dots for each individual pixel.

Note that the dithering mask used in the aforementioned Step S130 is a dithering mask that is generated so as to control the degradation of the printing quality of the image data D, even when there is positional shift in the print head tips HT 1 through HT 15, and the details thereof will be described in

Section A-4, “Method for Generating and Method for Using the Dithering mask.”

Additionally, in the half toning process, after data indicating whether or not a dot is to be formed in each pixel is obtained from the gradation data for each color C, M, Y, and K, then the control unit 20 prints an image through forming dots on the printer paper according to this control data, as the process of the printing controlling unit 32 (Step S140). That is, the paper feeding motor 84 illustrated in FIG. 1 is driven, and, in coordination with this motion, ink droplets are sprayed from the printer head 70 based on the dot data. The result is that the image data D will be printed by performing ink dots of the appropriate colors at the appropriate locations.

A-b 4. Method for Generating and Method for Using the Dithering mask

In the printer 8 as set forth in the present embodiment, as described above, the printer head 70 is structured by arranging the print head tips HT 1 through HT 15. There may be cases wherein positional shift has occurred in these print head tips HT 1 through HT 15. Positional shift refers to the print head tips HT 1 through MT 15 being positioned in a state shifted from the proper position wherein they actually should be positioned, as a problem with manufacturing precision. For example, the print head 70 in the printer 8 has a nozzle pitch of 1600 dpi, and thus even if there is a minute shift of 16 μm of the position wherein any of the print head tips HT 1 through HT 15 is positioned relative to the neighboring print head tip, then there will have been a shaft of one dot in the printed image.

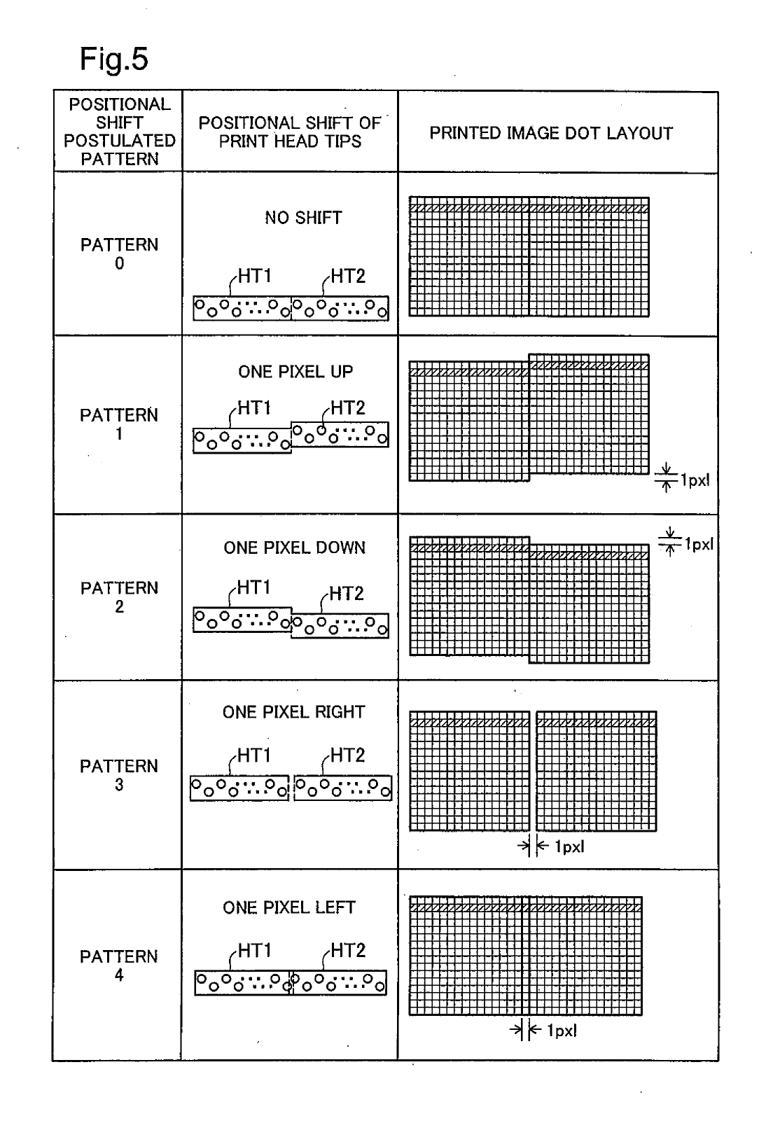

FIG. 5 will be used to explain this positional shift of the print head tips UT 1 through HT 15 in detail. In the figure, Pattern 0 illustrates the case wherein the print head tip HT 1 and the print head tip HT 2 are positioned properly, without the occurrence of positional shift. The print head tips HT 1 and HT 2 are disposed in a zigzag pattern, as described above, but for simplicity are positioned arrayed in a straight line in the center portion of the figure, to illustrate the positional relationship of the print head tips HT 1 and HT 2. In this way, in a state wherein no positional shift has occurred between the print head tips HT 1 and UT 2, the dots in the printed image, formed by ink that is sprayed from the print head tips HT 1 and UT 2, will be disposed in a straight line, formed on the same raster, as illustrated in the right-hand column of the figure. That is, there is no degradation of the printing quality.

On the other hand, Pattern 1 in the figure illustrates the case wherein the print head tip HT 2 has shifted up one pixel up from the proper location relative to the print head tip HT 1, as is shown in the center of the figure. In this case, as is shown in the right-hand column of the figure the raster that should be formed as a straight line is formed including the step difference in the junctions between the print head tips HT 1 and UT 2, or in other words, the image quality will be degraded.

Similarly, Pattern 2 shows the case wherein the print head tip UT 2 is positioned shifted one pixel down from the proper position relative to the print head tip HT 1, Pattern 3 shows the case wherein the print head tip UT 2 is positioned shifted one pixel to the right from the proper position relative to the print head tip HT 1, and Pattern 4 shows the case wherein the print head tip HT 2 is positioned shifted one pixel to the left from the proper position relative to the print head tip HT 1. In all of these cases, there is degradation to the printing quality at the junctions between the print head tips HT 1 and HT 2.

Such positional shifts of the print head tips HT 1 through HT 15 are not limited to a single direction such as up, down, left, or right, as shown in FIG. 5, and not limited to a single pixel distance, but may occur in any direction at any distance.

The printer 8 in the present embodiment can perform the half toning process of the aforementioned Step S130 using a dithering mask capable of reducing the degradation in the printed image quality, even when there is positional shift of this type in the print head tips HT 1 through HT 15. A method for producing this type of dithering mask, and the method for using the dithering mask that has been produced, will be described below.

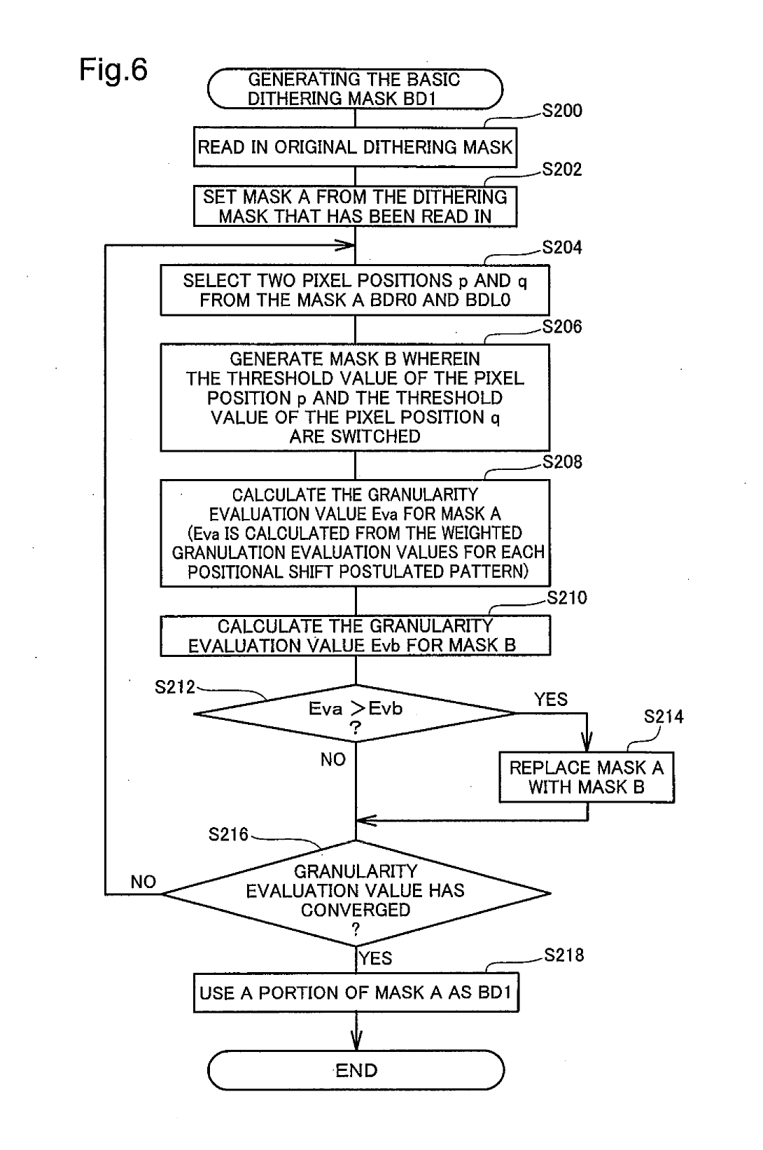

FIG. 6 shows the series of steps for generating the dithering mask DM that is referenced in the half toning process in the aforementioned Step S130. When generating the dithering mask DM, first a dithering mask to be used as the base is read in (Step S200). This dithering mask can be used as an optimal dithering mask when there is no positional shift, for example, in the print head tips HT 1 through HT 15. In the optimization of dithering masks can use any of a variety of known optimization methods such as, for example, in the method illustrated in FIG. 16 of the publicly known document Japanese Unexamined Patent Application Publication 2007-15359, or the granularity index illustrated in FIG. 11 of Japanese Unexamined Patent Application Publication 2007-15359 may be used. The method in FIG. 16 of this publicly known document has the same flow as the method in FIG. 6 in the present application, described below. Moreover, the granularity index in FIG. 11 of this known document is an index that is calculated by taking the power spectrum FS of the Fourier transform of the image, weighting the power spectrum FS thus obtained according to the visual sensitivity characteristics VTF (visual transfer function) relative to the spatial frequencies of human vision, and then integrating over each of the spatial frequencies, and is expressed as Equation 1. Note that the RMS granularity, or the like, can be used instead of the granularity index, to use a different evaluation index for the dot dispersion characteristics.

$$granularity index = k \int FS ( u ) VTF ( u ) d u \\ VTF ( u ) = 5.05 exp ( \frac{- 0.138 π L u}{180} ) \{ 1 - exp ( \frac{- 0.1 π L u}{180} ) \} \\ FS ( u ) \text{:} power spectrum K \text{:} coefficient \qquad ( 1 )$$

Next, the dithering mask that has been read in is set as the dithering mask A (Step S202). Additionally, two pixel locations (the pixel location p and the pixel location q) are selected at random from the dithering mask A (Step S204), and the threshold value that is set at the selected pixel position p is replaced by the threshold value that is set at the selected pixel position q, and the dithering mask that is thus obtained is set as the dithering mask B (Step S206).

Next the evaluation value Eva (the total granulation evaluation value Eva) that was calculated using the aforementioned granulation index is calculated for the dithering mask A (Step S208). Here the total granulation evaluation value Eva is a total evaluation value wherein m types of positional shift postulated patterns (where m is an arbitrary integer) are generated with postulated directions and distances for the positional shifts of the print head tips are created, and weightings are applied to the granulation evaluation values Evam (where m is the postulated number of the positional shift postulated pattern) for the dot array when each of the positional shifts of the individual positional shift postulated patterns occurs. That is, Eva uses the waiting factors a through ζ, and is expressed in the following equation (2):

Eva=(Eva1×α+Eva2×β+Eva3×γ+ . . . Evam×ζ)/ (α+β+γ+ζ) (2)

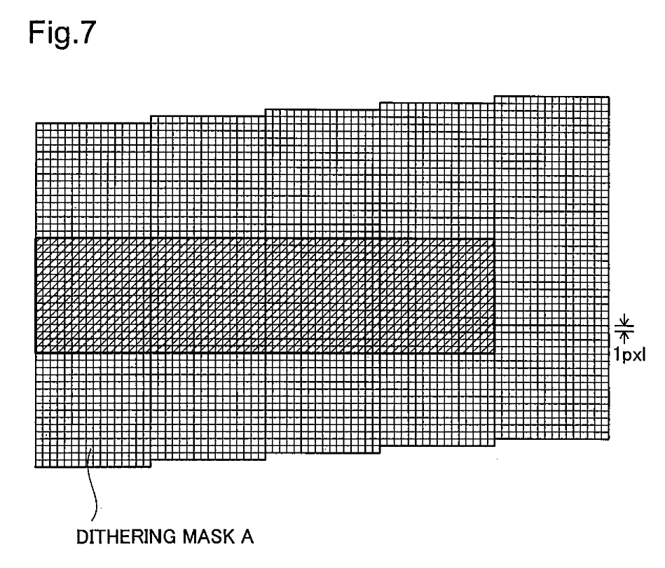

Here the granularity evaluation value Evam is an evaluation value that is calculated as follows. First a dithering mask is set corresponding to a postulated positional shift pattern. This process will be explained using FIG. 7 using, as an example, a case wherein the positional Pattern 1, illustrated in FIG. 5, has occurred (that is, a positional shift of one pixel up). FIG. 7 illustrates the state wherein there are dithering masks A, each having the same threshold values, are provided laid out continuously 3× in the vertical direction and 5× in the horizontal direction, shifted by one pixel upward each time. Each dithering mask A has the same threshold values in the mutually corresponding pixel locations. From these continuous dithering masks A, threshold values in an amount equal to four of the dithering masks A (the portion indicated by the diagonal lines) are extracted.

Using the extracted dithering mask to apply the dithering method to an image with 256 different gradation values, from 0 to 255, produces 256 different images that are expressed by whether or not a dot is formed. After performing the granularity index, as described above, for the 256 images thus obtained, the average value is then calculated, and the value thus obtained is used as the granularity evaluation value. Note that when calculating the granularity evaluation value, weighting factors may be applied to specific gradation values (for example, low gradation values wherein the dots are particularly noticeable) to perform the averaging, rather than simply taking the arithmetic mean of the 256 granularity indexes.

Note that the threshold values extracted from the continuous dithering masks A may be N times (where N is an integer greater than 1) the dithering mask A, but preferably, there are at least 4 times the dithering mask A, as in the present embodiment. This is because when calculating the granularity index using Fourier transforms, which assume repetition, if N is small, for example, if N=2, then there will be a large impact by the side portions that have been extracted, because it will appear as though there is no positional shift. N is preferably at least 4 because this is a relatively small number of a level wherein this influence is not a practical problem.

In the present embodiment, the aforementioned total granularity evaluation value Eva assumes the five patterns illustrated in FIG. 5 as the positional shift postulated patterns (that is, Pattern 0 wherein there is no positional shift and Patterns 1 through 4 wherein there is positional shift), where the weighting factor applied to Pattern 0 is twice that which is set for the other patterns, as shown in Equation (3). In this way, the practicality can be improved through setting the weighting factors so as to increase the contribution of the granularity evaluation value Evam corresponding to the positional shift patterns that, experimentally, have a high probability of occurring.

Eva=(Eva0×2+Eva1+Eva2+Eva3+Eva4)/6

After obtaining the granularity evaluation value Eva for the dithering mask A in this way, the same is also done for the dithering mask B-to calculate the granularity evaluation value Evb (Step S28). Following this, the granularity evaluation value Eva of the dithering mask A and the granulation evaluation value Evb of the dithering mask B are compared (Step S212). At this time, if it is determined that the granularity evaluation value Evb is the smaller one (Step S212: YES), then the dithering mask B, wherein the threshold values set in the two pixel locations were switched, can be considered to be superior in terms of the printing dot dispersion characteristics. Given this, in this case the dithering mask B replaces the dithering mask A (Step S214). On the other hand, if the granularity evaluation value Evb of the dithering mask B is determined to be larger than the granularity evaluation value Eva of the dithering mask A (Step S212: NO), then the dithering mask is not replaced.

In this way, it is only when the granularity evaluation value Evb of the dithering mask B is determined to be smaller than the granularity evaluation value Eva of the dithering mask A and an operation has been performed to replace the dithering mask B for the dithering mask A that a determination is made as to whether or not the granularity evaluation value has converged (Step S216). That is, because the original dithering mask used that which was optimized to the state wherein there was no positional shift, a large value will be obtained for the granularity evaluation value immediately after commencing the operations such as described above. However, if a smaller granularity evaluation value is obtained through switching the threshold values that have been set in two different pixel locations, then the dithering mask wherein the threshold values have been replaced is used, and if the operation described above is then repeated on this dithering mask, then the granularity evaluation values obtained will become smaller, and eventually can be expected to stabilize at some value. In Step S216, a determination is made as to whether or not the overall granularity evaluation value has stabilized, or in other words, whether or not the granularity evaluation value can be considered to have stopped decreasing. When it comes to whether or not the granularity evaluation value has converged, it can be determined that the granularity evaluation value has converged it for example, when the granularity evaluation value Evb of the dithering mask B is smaller than the granularity evaluation value Eva of the dithering mask A, the amount of reduction of the granularity evaluation value is calculated, and this amount of reduction is stabilized below a constant value over multiple iterations.

If it is determined that the granularity evaluation value has not converged (Step S216: NO), then processing returns to the aforementioned Step S204, and the series of operations is repeated after selecting two new pixel positions are selected. While iterating these operations in this way, eventually the granularity evaluation value will converge, and when it has been determined that the granularity evaluation value has converged (Step S216: YES), then the set of threshold values that is half as wide as the dithering mask A at this time is used as the base dithering mask DM (Step S218).

However, in this method the granularity evaluation value may converge to a local optimal prior to achieving a value that is adequately small. The method known as simulated annealing may be used in order to avoid this. Specifically, a noise nz of an appropriate amplitude, which changes each time, may be applied to the granularity evaluation value Eva in the aforementioned Step S212, for example, before making the comparison. That is, the determination is made as to whether or not Eva+nz>Evb. If the comparison is performed in this way after adding the noise nz, then the dithering masks will be switched if the result of adding the noise nz to the granularity evaluation value Eva is larger than the granularity evaluation value Evb, even when the granularity evaluation value Evb is larger than the granularity evaluation value Eva (that is, even when the printing dot dispersion characteristics of the dithering mask A are superior to those of the dithering mask B).

Even though the granularity evaluation value becomes larger (that is, the printing dot dispersion characteristics are worsened) temporarily when the dithering mask is replaced in this way, if the amplitude of the noise nz is gradually decreased and iterations are performed an adequate number of times (the aforementioned Step S216: NO process), and ultimately the noise nz is decreased to zero, then even though the number of iterations before convergence will be increased, there will be no falling into any local optimum. As a result, it is possible for the granularity evaluation value to converge at a lower value.

In this way, by considering the granularity evaluation values Evam in relation to all of the positional shift postulated patterns, it is possible to cause Δ0>Δ1 for the difference Δ0 between the granularity evaluation value Eva01 in the case wherein the most appropriate dithering mask is applied to a printer without positional shift when postulating the case wherein there is no positional shift in the print head tips and the granularity evaluation value Eva01 for the case when applied to a printer with positional shift, and the difference Δ1 between the granularity evaluation value Eva11 in the case wherein the most dithering mask as set forth in the present invention is applied to a printer without positional shift and the granularity evaluation value Eva12 for the case when applied to a printer with positional shift. In other words, the dithering mask DM as set forth in the present invention can formed dots that are dispersed well, at least to some degree, through suppressing, to below a specific value, the differences in the granulation evaluation levels for all of the Patterns 1 through 4 wherein there is positional shift, and not just Pattern 0 wherein there is no positional shift. This type of dithering mask DM is stored in the dithering mask memory unit 52.

Note that in the present embodiment, patterns were postulated, as the aforementioned positional shift postulated patterns, wherein the positional shift of the print head tip was either a pattern with no positional shift, or with a shift by one pixel up, down, left, or right; however, the amount of the positional shift may be postulated as any amount, such as 0.3 pixels, 0.5 pixels, 1.5 pixels, etc. Moreover, the positional shift is not limited to the independent directions of up, down, left, and right, but positional shift postulated patterns may also postulate combinations of up, down, left, and right, such as a positional shift of 0.5 pixels up and 0.3 pixels to the left. In such a case, it is possible to respond to the various types of positional shifts.

As described above, when the amount of the positional shift is postulated as being a non-integer value, then the number of pixels in the image data D may be increased virtually so that the image shift amount will be an integer when producing the base dithering mask. For example, when postulating a positional shift of 0.5 pixels up and 0.5 pixels to the right, then one pixel of the image data D can be handled, virtually, as comprising a total of four pixels, that is, two pixels in the vertical direction by two pixels in the horizontal direction, having identical gradation values. In accordance with this, one threshold value of the dithering mask is handled as being structured, virtually, from four identical threshold values. At this point, the basic dithering mask BD should be generated postulating, virtually, a positional shift of a one pixel shift upward and a one pixel shift to the right.

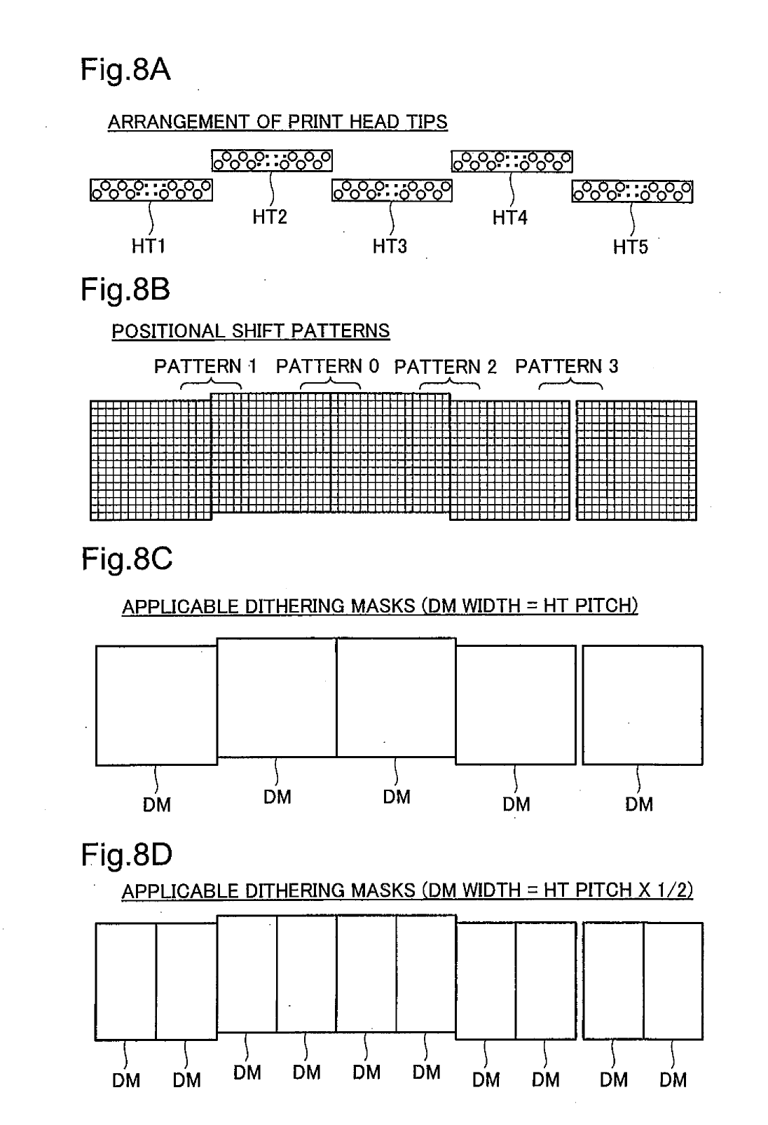

The method of using the dithering mask DM that is generated in this way will be explained using FIG. 8A through FIG. 8D. The control unit 20 of the printer 8 is that which performs the half toning process using the optimal dithering masks generated referencing the dithering mask pattern table 52 in the aforementioned Step S130. FIG. 8A illustrates the state wherein the print head tips HT 1 through HT 5 are lined up. In contrast, FIG. 8B illustrates a positional shift between the print head tips HT 1 through HT 5. As is illustrated, there is a positional shift following Pattern 1 illustrated in FIG. 5 between the print head tip HT 1 and the print head tip HT 2. Similarly, there is a Pattern 0 shift (that is, no positional shift) between the print head tip HT 2 and the print head tip HT 3, a Pattern 2 positional shift between the print head tip HT 3 and the print head tip HT 4, and a Pattern 3 positional shift between the print head tip HT 4 and the print head tip HT 5.

As described above, the width of the dithering mask DM used in the present embodiment is a multiple of 1/N (where N is a nonzero positive integer) of the pitch of the print head tips HT I through HT 5, as has already been stated above, but when N=1, or in other words, when the width of the dithering mask DM is equivalent to the number of pixels corresponding to the pitch of the print head tips HT 1 to HT 5, (that is, when the width of the dithering mask DM is the equivalent of 320 pixels) than the state wherein the dithering mask DM is applied to each of the pixel positions of the image data D is shown in FIG. 8C.

Because the number of pixels corresponding to the pitch of the print head tips HT 1 to HT 5 is equivalent to the width of the dithering mask DM, it is possible to apply the dithering mask DM at each pixel location so as to cause a positional relationship between the print head tips HT 1 to HT 5 and the dithering mask DM such that the connecting portions of the print head tips will always be coincident with the junctions between dithering masks DM, as is shown in the figure. As is shown in FIG. 7, the dithering mask DM is a dithering mask that was produced based on the premise of this type of positional relationship, so it is possible to have excellent dot dispersion characteristics, and to suppress degradation in the printed image quality, at each junction location between the individual print head tips. In other words, the same dithering mask DM can be used to ensure excellent dot dispersion characteristics and to suppress degradation of the printed image quality at the junctions between the individual print head tips.

In the case wherein N=2, or in other words, wherein the width of the dithering mask DM is one half the number of pixels corresponding to the pitch of the print head tips HT 1 to HT 5 (that is, the width of the dithering mask DM is equivalent to 160 pixels), the state wherein the dithering mask DM is applied at each pixel location of the image data D is illustrated in FIG. 8D. Even in this case, as with the case of N=1, the dithering mask DM can be applied to each pixel location so as to have a positional relationship so that the junctions in the dithering mask DM coincide with the print head tip connecting portions. That is, the same dithering mask DM can be used to ensure excellent dot dispersion characteristics and to suppress degradation of the printed image quality at the junctions between the individual print head tips.

The positional relationship between this type of dithering mask DM and the print head tips HT 1 to HT 15 is not limited to the cases described above in FIG. 8C and FIG. 8D, but rather can be established whenever the width of the dithering mask DM is 1/N times the number of pixels that are equivalent to the pitch of the print head tips HT 1 to HT 15 (where N is an integer larger than 2)

In a line printer of this structure, the width of the dithering mask that is used in the half toning process is a multiple of 1/N (where N is a nonzero positive integer) times the number of pixels corresponding to the pitch of the print heads HT 1 to HT 15, so the print heads HT 1 to HT 15 and the dithering mask DM will have a positional relationship wherein the connecting portions between the print heads will always coincide the junctions between dithering masks. Consequently, because there is no application of a single dithering mask spanning printing regions corresponding to multiple print heads, it is possible to suppress the degradation in printed image quality due to differences in characteristics between print heads.

Additionally, in a line printer 8 of this structure, the width of the dithering mask that is used in the half toning process is a multiple of 1/N (where N is a nonzero positive integer) times the number of pixels corresponding to the pitch of the print heads HT 1 to UT 15. Because of this it is possible to apply the appropriate dithering mask so as to cause there to be always the same positional relationship between the print head tips HT 1 to HT 15 and the dithering mask DM that was produced taking into account the dot dispersion characteristics in case there is a positional shift between the print head tips HT 1 to HT 15. Consequently, it is possible to repetitively apply the same dithering mask to multiple print head tip connecting portions with the same positional relationship, meaning that it is not necessary to provide different dithering masks for each connecting portion between each of the print head tips HT 1 through UT 15, reducing the overhead in the dithering mask generation and enabling efficient half toning processing.

B. Modifications:

In the present embodiment, a case was illustrated wherein the layout was with the same pitch as the print head tips HT 1 to HT 15; however, the print head tips HT 1 to HT 15 may instead be arranged with two or more different pitches. In such a case, the same effects as in the present embodiment can be achieved if a half toning process is performed using a dithering mask that is 1/N (where N is a nonzero positive integer) times the greatest common denominator of the numbers of pixels corresponding to the two or more different types of print head pitches. For example, if the lengths of the print head tip HT 1 and the print head tip HT 15 were both lengths corresponding to 160 printing pixels, and the print head tips HT 2 and the print head tip ST 14 both had lengths corresponding to 240 pixels, while the lengths of the print head tips HIT 3 to HT 13 were lengths corresponding to 320 pixels, then a dithering mask should be used that is 1/N (where N is a nonzero positive integer) times 80 pixels, which is the greatest common denominator of the three different pitches: 160 pixels, 240 pixels, and 320 pixels.

Although, in the above, an explanation was given for an embodiment as set forth in the present invention, the present invention is not limited to this embodiment, but rather, of course, may be embodied in a variety of forms without departing from the scope or spirit of the present invention. Moreover, the present invention may be embodied not only in the line printer illustrated in the present embodiment, but also in the form of a halftone processing method, the dithering mask, and the like.

What is claimed is:

1. A line printer comprising:
a plurality of print heads arrayed with an identical pitch in a line across a printing range;
half toning unit that performs a half toning process, on image data, using a dithering mask that has a size that is a multiple of 1/N (where N is a nonzero positive integer) times a number of pixels corresponding to the print head pitch; and
printing unit that drives said print heads according to the results of the half toning process to form an image through forming dots on a single raster.

2. A line printer comprising:
a plurality of print heads arrayed with at least two different layout pitches in a line across a printing range;
half toning unit that performs a half toning process, on image data, using a dithering mask that has a size that is a multiple of 1/N (where N is a nonzero positive integer) of a greatest common factor of the number of pixels corresponding to the plurality of print head pitches in a direction in which the print heads are arrayed; and
printing unit that drives said print heads according to the results of the half toning process to form an image through forming dots on a single raster.

3. A line printer in accordance with claim 1, wherein:
said plurality of print heads comprise at least three print heads; and
the dithering mask is generated taking into account dot distribution characteristics when adjacent print heads are located at a position shifted in a specific direction and in a specific distance from a target position.

4. A method for forming an image in a line printer, the method comprising:
preparing a dithering mask;
performing a half toning process on image data using the dithering mask; and
printing an image data by forming dots on a single raster by driving a plurality of print heads, arrayed with an identical pitch across a print range, in accordance with the results of the half toning process; wherein:
a size of the dithering mask in the direction of the array of print heads is a multiple of 1/N (where N is a nonzero positive integer) times a number of pixels corresponding to the layout pitch of the print heads.

5. A method for forming an image in a line printer, wherein:
preparing a dithering mask;
performing a half toning process on image data using the dithering mask; and
printing an image by forming dots on a single raster by driving a plurality of print heads, arrayed with at least two pitches across a print range, in accordance with the results of the half toning process; wherein:
a size of the dithering mask in the direction of the array of print heads is a multiple of 1/N (where N is a nonzero positive integer) times the maximum common denominator of the numbers of pixels corresponding to the plurality of print head pitches.
